(19) United States
(12) Patent Application Publication
(10) Pub. No.: US 2015/0012319 A1
(43) Pub. Date: Jan. 8, 2015

(54) Employee location noticeboard

(71) Applicant: Marja Lee Freeman, Burke, VA (US)

(72) Inventor: Marja Lee Freeman, Burke, VA (US)

(21) Appl. No.: 14/324,218

(22) Filed: Jul. 6, 2014

Related U.S. Application Data
(60) Provisional application No. 61/843,365, filed on Jul. 6, 2013.

(51) Int. Cl. G06Q 10/10

(52) U.S. Cl. CPC G06Q 10/109
USPC 705/7.13

(57) ABSTRACT

An employee location noticeboard is in the form of a dry-erase board, with a list of prepared options and checkboxes providing specific details about the employee's current location and estimated time of return. The noticeboard also provides some options that are not intended to be actually used, but instead may provide harmless amusement for the reader. A method of producing noticeboard content provides for determining legitimate reasons for an employee to be away from his or her desk, determining not legitimate but humorous reasons for the employee to be away, and printing the list on the noticeboard. The noticeboard features suction cups for easy mounting on an office door.

### CROSS-REFERENCE TO RELATED APPLICATIONS

This application claims priority to U.S. Provisional Application No. 61/843365, filed Jul. 6, 2014, which is hereby incorporated by reference.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to office supplies and accessories and in particular to an employee location noticeboard. Many offices have adopted the use of noticeboards indicating whether each employee is in the office, or out of the office. Several versions, including dry-erase boards and magnetic boards, exist in the prior art and are already in widespread use. However, when using any of these existing products, if an employee is in the building but away from his desk, no one knows where he is, or whether he will be attending a particular meeting or other event later in the day. Also, a degree of humor is helpful in reducing stress and tension in the workplace, and existing noticeboards make no accommodations for humor. An employee location noticeboard, providing specific details about the employee's current location and estimated time of return, and providing some options that are not intended to be actually used, but instead may provide harmless amusement for the reader, would resolve these problems.

### SUMMARY OF THE INVENTION

Accordingly, the invention is directed to an employee location noticeboard. The noticeboard is in the form of a dry-erase board, with a list of prepared options and checkboxes providing specific details about the employee's current location and estimated time of return. The noticeboard also provides some options that are not intended to be actually used, but instead may provide harmless amusement for the reader. The noticeboard features suction cups for easy mounting on an office door.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a perspective view of the first exemplary embodiment, displaying the noticeboard 10, the marker clip 11, the dry erase marker 12, the preprinted content 14, the title 15, the list 16, the checkboxes 17, and the blank fields 18.

FIG. 2 shows a perspective view of the first exemplary embodiment of the pen portion of the system, displaying the noticeboard 10, the marker clip 11, the dry erase marker 12, the suction cups 13, and the blank fields 20.

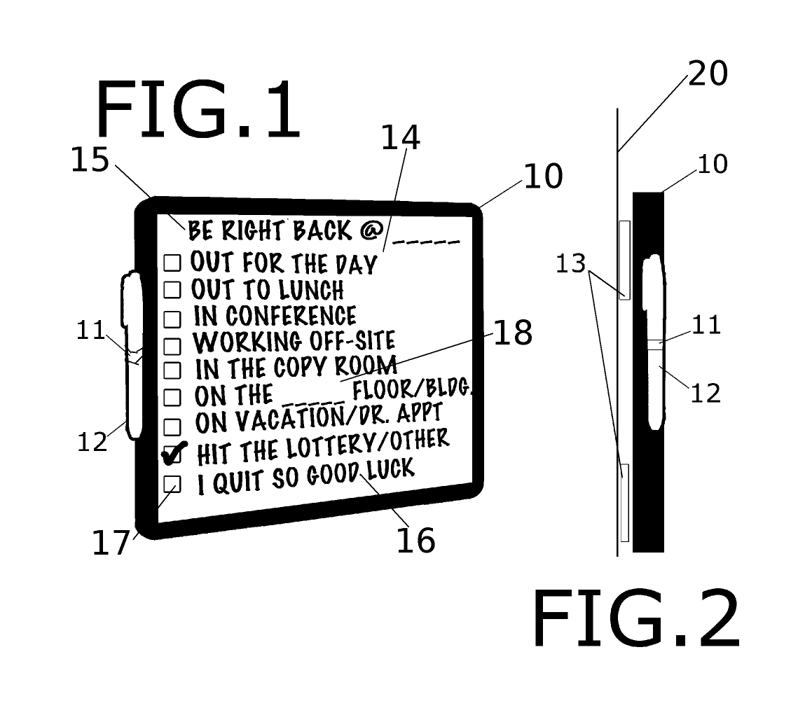

### DETAILED DESCRIPTION OF THE INVENTION

Referring now to the invention in more detail, the invention is directed to an employee location noticeboard. The noticeboard 10 is in the form of a dry-erase board, with preprinted and non-erasable content 14. The content includes a title 15, a list 16 of prepared options and checkboxes 17 or similarly designatable graphical elements. By designating a checkbox 17 and filling any blank fields 18, the absent employee may provide specific details about the employee's current location and estimated time of return. The noticeboard 10 may also provide some options that are not intended to be actually used, but instead provide harmless amusement for the reader.

The noticeboard 10 features suction cups 13 for easy mounting and re-positioning on an office door or other vertical surface 20, such as a computer screen or filing cabinet. Alternative mounting means, such as magnets, hook and loop fasteners, screws, nails, hanging hooks, etc., may alternatively be provided. The noticeboard 10 also features a dry erase marker 12, secured releasably and by friction to the side of the noticeboard 10 with a marker clip 11. The noticeboard 10 provides options, in the form of a list of checkbox messages, which will identify the location of one employee and the employee's expected time of return.

Such options would preferably include “Be right back @______ ,” as the first option on the list, providing a space for the employee to fill in the expected time of return with the dry-erase marker 12. Additional options which may be offered by the noticeboard 10 include:

“Out for the day.”

“Out to lunch.”

“In conference /______.”

“Working off-site.”

“In the copy room.”

“On the ______ floor/bldg.”

“On vacation, back on ______”

To provide a degree of harmless amusement, the noticeboard 10 may offer one, two, or several options at the end of the list 16 which are never intended to be used, but may provide some amusement to the reader. Examples include:

“Hit the lottery/other.”

“I quit so good luck.”

Alternate embodiments, featuring additional options on the list, or a different combination of options, are also contemplated.

The invention may be further understood as a method of preparing the preprinted content 14 of the noticeboard 10 to improve workplace efficiency and morale. The method may be understood as comprising the steps of listing legitimate reasons that an employee may not be found at his or her desk, including any organization-specific or role-specific activities that the employee may be engaged in; then further listing a small number of not legitimate, but humorous, reasons to be away from the desk; for each reason, both legitimate and humorous, providing a blank, if necessary, for specific information; optionally giving the resulting list 16 a title 15, and then printing the list 16 on a noticeboard 10 having the physical properties disclosed herein.

To use the noticeboard 10, the user affixes the noticeboard 10 using the suction cups 13 to the outer surface of his office door, or another smooth vertical surface, such as a computer screen or filing cabinet. The user then removes the dry-erase marker 12 from the marker clip 11, marks the checkbox next to the option that best describes the circumstances of his departure from his work station, and fills in the blank indicating the estimated time of his return. The user then affixes the dry-erase marker 12 to the noticeboard 10 using the marker clip 11.

The noticeboard 10, the marker clip 11, and the dry erase marker 12 would preferably be manufactured from durable, rigid materials that are easily cleaned, such as high-impact plastic. The suction cups 13 would preferably be manufactured from a flexible material, such as rubber or silicone.

Components and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An employee location noticeboard comprising a dry erase noticeboard; a marker clip; said marker clip being affixed to the side of said dry erase noticeboard; said marker clip being configured to releasably and frictionally secure a dry erase marker; a mounting means for mounting said noticeboard to a vertical surface; a noticeboard content; said noticeboard content being preprinted on said dry erase noticeboard in a permanent and non-erasable manner; said content comprising a list of prepared options; each of said list of prepared options being accompanied by a checkbox; and each of said list of prepared options describing a reason for the user of said noticeboard being away from the location of said noticeboard.

2. The employee location noticeboard of claim 1 wherein said noticeboard content further comprises a title.

3. The employee location noticeboard of claim 1 wherein at least one of said list of prepared options include a blank wherein the user of said noticeboard may write specific information pertaining to that of said list of prepared options to which the specific said blank pertains.

4. The employee location noticeboard of claim 1 wherein at least one of said list of prepared options provides a not legitimate and humorous reason for the user of said noticeboard being away from the location of said noticeboard.

5. The employee location noticeboard of claim 2 wherein at least one of said list of prepared options include a blank wherein the user of said noticeboard may write specific information pertaining to that of said list of prepared options to which the specific said blank pertains.

6. The employee location noticeboard of claim 2 wherein at least one of said list of prepared options provides a not legitimate and humorous reason for the user of said noticeboard being away from the location of said noticeboard.

7. The employee location noticeboard of claim 3 wherein at least one of said list of prepared options provides a not legitimate and humorous reason for the user of said noticeboard being away from the location of said noticeboard.

8. The employee location noticeboard of claim 5 wherein at least one of said list of prepared options provides a not legitimate and humorous reason for the user of said noticeboard being away from the location of said noticeboard.

9. A method of preparing noticeboard content for an employee location noticeboard according to claim 1 comprising listing legitimate reasons for the user of said noticeboard being away from the location of said noticeboard; and applying the resulting list to said noticeboard content.

11. A method of preparing noticeboard content for an employee location noticeboard according to claim 2 comprising listing legitimate reasons for the user of said noticeboard being away from the location of said noticeboard; providing said title; and applying the resulting list to said noticeboard content.

12. A method of preparing noticeboard content for an employee location noticeboard according to claim 3 comprising listing legitimate reasons for the user of said noticeboard being away from the location of said noticeboard; for each legitimate reason for the user of said noticeboard being away from the location of said noticeboard, providing, if necessary, a relevant blank; and applying the resulting list to said noticeboard content.

13. A method of preparing noticeboard content for an employee location noticeboard according to claim 4 comprising listing legitimate reasons for the user of said noticeboard being away from the location of said noticeboard; further listing not legitimate and humorous reasons for the user of said noticeboard being away from the location of said noticeboard; and applying the resulting list to said noticeboard content.

14. A method of preparing noticeboard content for an employee location noticeboard according to claim 5 comprising listing legitimate reasons for the user of said noticeboard being away from the location of said noticeboard; for each legitimate reason for the user of said noticeboard being away from the location of said noticeboard, providing, if necessary, a relevant blank; providing said title; and applying the resulting list to said noticeboard content.

15. A method of preparing noticeboard content for an employee location noticeboard according to claim 6 comprising listing legitimate reasons for the user of said noticeboard being away from the location of said noticeboard; further listing not legitimate and humorous reasons for the user of said noticeboard being away from the location of said noticeboard; providing said title; and applying the resulting list to said noticeboard content.

16. A method of preparing noticeboard content for an employee location noticeboard according to claim 7 comprising listing legitimate reasons for the user of said noticeboard being away from the location of said noticeboard; further listing not legitimate and humorous reasons for the user of said noticeboard being away from the location of said noticeboard; for each legitimate reason for the user of said noticeboard being away from the location of said noticeboard and for each not legitimate and humorous reasons for the user of said noticeboard being away from the location of said noticeboard, providing, if necessary, a relevant blank; and applying the resulting list to said noticeboard content.

17. A method of preparing noticeboard content for an employee location noticeboard according to claim 8 comprising listing legitimate reasons for the user of said noticeboard being away from the location of said noticeboard; further listing not legitimate and humorous reasons for the user of said noticeboard being away from the location of said noticeboard; for each legitimate reason for the user of said noticeboard being away from the location of said noticeboard and for each not legitimate and humorous reasons for the user of said noticeboard being away from the location of said noticeboard, providing, if necessary, a relevant blank; providing said title; and applying the resulting list to said noticeboard content.
